(19) United States
(12) Patent Application Publication
(10) Pub. No.: US 2018/0359449 A1
(43) Pub. Date: Dec. 13, 2018

(54) MONITORING DEVICE, MONITORING SYSTEM, AND MONITORING METHOD

(71) Applicant: PANASONIC INTELLECTUAL PROPERTY MANAGEMENT CO., LTD., Osaka-shi, Osaka (JP)

(72) Inventors: Yuichi MATSUMOTO, Kanagawa (JP); Yoshiyuki KAMINO, Kanagawa (JP); Takeshi WATANABE, Kanagawa (JP)

(73) Assignee: PANASONIC INTELLECTUAL PROPERTY MANAGEMENT CO., LTD., Osaka-shi, Osaka (JP)

(21) Appl. No.: 15/775,475

(22) PCT Filed: Nov. 11, 2016
(86) PCT No.: PCT/JP2016/004870

§ 371 Date: May 11, 2018

(30) Foreign Application Priority Data
Nov. 27, 2015 (JP) 2015-231710

(51) Int. Cl. H04N 7/18; H04N 5/272

(52) U.S. Cl. CPC H04N 7/181; H04N 5/272

(57) ABSTRACT

In addition to reliably protecting the privacy of individuals, it is possible to display a monitoring image from which a congested situation in a facility may be intuitively grasped. The monitoring device of the present disclosure includes first processing unit that performs image processing for reducing identifiability of an object appearing in a captured image on the captured image captured by imaging unit, second processing unit that detects a moving object from the captured image to generate a mask image corresponding to the image area of the moving object, and image output controller that generates and outputs the monitoring image on which the mask image generated by second processing unit is superimposed on the identifiability-reduced image generated by first processing unit.

### TECHNICAL FIELD

The present disclosure relates to a monitoring device, a monitoring system, and a monitoring method for generating and outputting a monitoring image on which privacy mask processing is performed on a captured image obtained by imaging a target area.

### BACKGROUND ART

In a facility such as a railway station and an event venue, a surveillance system that images in the facility with cameras and monitors the situation in the facility with the images of the cameras has been adopted, but if the images captured by the cameras installed in the facility are distributed to general users on the Internet, the users may confirm the congested situation in the facility and the like without visiting the site, so the convenience of the users may be enhanced.

Here, it is not a problem when using images of cameras for monitoring purposes for crime prevention and disaster prevention, but when distributing the images of the cameras to general users, it is desirable to protect the privacy of people.

In response to such a desire to protect the privacy of people, in related art, a technique of performing image processing (privacy mask processing) such as mosaic processing and blurring processing on an area in which the face of the person is detected in the images of the camera, or the entire images of the camera is known (see PTL 1).

### CITATION LIST

### Patent Literature

PTL 1: Japanese Patent Unexamined Publication No. 5088161

### SUMMARY OF THE INVENTION

The monitoring device of the present disclosure includes a processor, wherein the monitoring device that generates and outputs a monitoring image on which privacy mask processing is performed on a captured image obtained by imaging a target area, and the processor performs image processing for reducing identifiability of an object appearing in the captured image on the captured image, detects a moving object from the captured image to generate a mask image corresponding to the image area of the moving object, and generates and outputs the monitoring image on which the mask image is superimposed on the identifiability-reduced image.

In addition, the monitoring system of the present disclosure is a monitoring system that generates a monitoring image on which privacy mask processing is performed on a captured image obtained by imaging a target area to distribute the image to a user terminal device. including a camera that images the target area, a server device that distributes the monitoring image to the user terminal device, and a user terminal device, either the camera or the server device performs image processing for reducing identifiability of an object appearing in the captured image on the captured image, detects a moving object from the captured image to generate a mask image corresponding to the image area of the moving object, and generates and outputs the monitoring image on which the mask image is superimposed on the identifiability-reduced image.

In addition, the monitoring method of the present disclosure is a monitoring method for causing an information processing device to perform processing of generating and outputting a monitoring image on which privacy mask processing is performed on a captured image obtained by imaging a target area, including performing image processing for reducing identifiability of an object appearing in the captured image on the captured image to generate an identifiability-reduced image, detecting a moving object from the captured image to generate a mask image corresponding to the image area of the moving object and detecting a moving object from the captured image to generate a mask image corresponding to the image area of the moving object, and generating and outputting the monitoring image in which the mask image is superimposed on the identifiability-reduced image.

According to the present disclosure, since the moving object such as a person and the like may clearly be distinguished from the background and visually recognized by the mask image, it is possible to clearly grasp the state of the moving object. Therefore, it is possible to intuitively grasp the congested situation in the facility and the like. In addition, the moving object whose moving object detection failed appears on an identifiability-reduced image, but because it is not possible to identify the moving object with this identifiability-reduced image, it is possible to reliably protect the privacy of individuals.

### BRIEF DESCRIPTION OF DRAWINGS

FIG. 1 is an overall configuration view of a monitoring system according to a first embodiment.

FIG. 2 is a plan view of an inside of a station building showing an example of the installation state of camera 1.

FIG. 3A is an explanatory view for explaining an overview of image processing performed by a camera 1.

FIG. 3B is an explanatory view for explaining an overview of image processing performed by camera 1.

FIG. 3C is an explanatory view for explaining an overview of image processing performed by camera 1.

FIG. 4A is an explanatory view for explaining an overview of image processing performed by camera 1.

FIG. 4B is an explanatory view for explaining an overview of image processing performed by camera 1.

FIG. 4C is an explanatory view for explaining an overview of image processing performed by camera 1.

FIG. 5A is an explanatory view for explaining an overview of image processing performed by camera 1.

FIG. 5B is an explanatory view for explaining an overview of image processing performed by camera 1.

FIG. 5C is an explanatory view for explaining an overview of image processing performed by camera 1.

FIG. 6A is an explanatory view for explaining an overview of image processing performed by camera 1.

FIG. 6B is an explanatory view for explaining an overview of image processing performed by camera 1.

FIG. 6C is an explanatory view for explaining an overview of image processing performed by camera 1.

FIG. 7 is a block view showing a hardware configuration of camera 1 and server device 3.

FIG. 8 is a functional block view of camera 1.

FIG. 9 is an explanatory view showing a monitoring screen displayed on user terminal device 4.

FIG. 10 is an explanatory view showing an overview of image processing performed by camera 1.

FIG. 11 is a functional block view of camera 101 and server device 102 according to a second embodiment.

FIG. 12 is an explanatory view showing a mask condition setting screen displayed on user terminal device 4.

### DESCRIPTION OF EMBODIMENTS

Prior to describing the embodiments, the problems in the related art will be briefly described. As in the technique in the related art, in a case where privacy mask processing is performed on an area where the face of a person is detected, if face detection fails, the image area of the person is excluded from the privacy mask processing and the image on which the person appears is output as it is. For this reason, the privacy of a person may not be securely protected, and there is a practical problem that the image of the camera may not be disclosed. In addition, as in the technique in the related art, in a case where privacy mask processing is performed on the entire images of the camera, it is possible to roughly recognize the outline of the imaging area, that is, where and what is located, but there is a problem that it is not possible to intuitively grasp the congested situation and the like of the facility because it is not possible to easily recognize the state of the person.

Thus, the main object of the present disclosure is to provide a monitoring device, a monitoring system, and a monitoring method that are capable of reliably protecting the privacy of individuals and displaying monitoring images from which a congested situation in a facility may be intuitively grasped.

A first disclosure made to solve the above problem includes a processor, wherein the monitoring device that generates and outputs a monitoring image on which privacy mask processing is performed on a captured image obtained by imaging a target area, and the processor performs image processing for reducing identifiability of an object appearing in the captured image on the captured image, detects a moving object from the captured image to generate a mask image corresponding to the image area of the moving object, and generates and outputs the monitoring image on which the mask image generated is superimposed on the identifiability-reduced image.

According to this, since the moving object such as a person and the like may clearly be distinguished from the background and visually recognized by the mask image, it is possible to clearly grasp the state of the moving object. Therefore, it is possible to intuitively grasp the congested situation in the facility and the like. In addition, the moving object whose motion detection failed appears on an identifiability-reduced image, but because it is not possible to identify the moving object with this identifiability-reduced image, it is possible to reliably protect the privacy of individuals.

In this case, image processing for reducing identifiability may be performed on the entire captured images, but an area, such as the ceiling of a building where it is clear that a moving object such as a person does not appear, may be excluded from the targets of the image processing for reducing identifiability.

In addition, in a second disclosure, the processor executes any one of mosaic processing, blurring processing, and blending processing as image processing for reducing identifiability.

According to this, it is possible to appropriately reduce the identifiability of the object appearing in the captured image.

In addition, in a third disclosure, the processor generates a transparent mask image representing a contour shape of a moving object.

According to this, since the mask image has transparency and a background image becomes transparent through a mask image portion in a monitoring image, it is easy to grasp the state of the moving object.

In addition, in a fourth disclosure, the processor generates a mask image in accordance with mask conditions set according to an operation input by a user, in which under the mask conditions, at least one display element of color, transmittance, presence/absence of a contour line of the mask image may be changed.

According to this, since the display elements of the mask image may be changed, it is possible to display a monitoring image that is easy for the user to see.

In addition, in a fifth disclosure, the processor generates a mask image in accordance with mask conditions set according to an operation input by a user, in which as the mask condition, a congested state display mode in which the mask image is generated with the color specified by a degree of congestion or contrasting density and transmittance with the same hue may be set.

According to this, the color of the mask image and the like dynamically changes according to the congested situation, and it is possible to grasp the real situation of a target area. In addition, when monitoring images for each of a plurality of target areas are displayed side by side, it is possible to compare the degree of congestion in each target area and instantaneously grasp the state of the plurality of target areas.

In addition, in a sixth disclosure, there is provided a monitoring system that generates a monitoring image on which privacy mask processing is performed on a captured image obtained by imaging a target area to distribute the image to a user terminal device. including a camera that images the target area, a server device that distributes the monitoring image to the user terminal device, and a user terminal device, either the camera or the server device performs image processing for reducing identifiability of an object appearing in the captured image on the captured image, detects a moving object from the captured image to generate a mask image corresponding to the image area of the moving object, and generates and outputs the monitoring image on which the mask image is superimposed on the identifiability-reduced image.

According to this, like the first disclosure, in addition to reliably protecting the privacy of individuals, it is possible to display a monitoring image from which a congested situation and the like in a facility may be intuitively grasped.

In addition, in a seventh disclosure, there is provided a monitoring method for causing an information processing device to perform processing of generating and outputting a monitoring image on which privacy mask processing is performed on a captured image obtained by imaging a target area, including performing image processing for reducing identifiability of an object appearing in the captured image on the captured image to generate an identifiability-reduced image, detecting a moving object from the captured image to generate a mask image corresponding to the image area of the moving object and detecting a moving object from the captured image to generate a mask image corresponding to the image area of the moving object, and generating and outputting the monitoring image in which the mask image is superimposed on the identifiability-reduced image.

According to this, like the first disclosure, in addition to reliably protecting the privacy of individuals, it is possible to display a monitoring image from which a congested situation and the like in a facility may be intuitively grasped.

Hereinafter, an embodiment of the present disclosure will be described with reference to drawings.

### First Embodiment

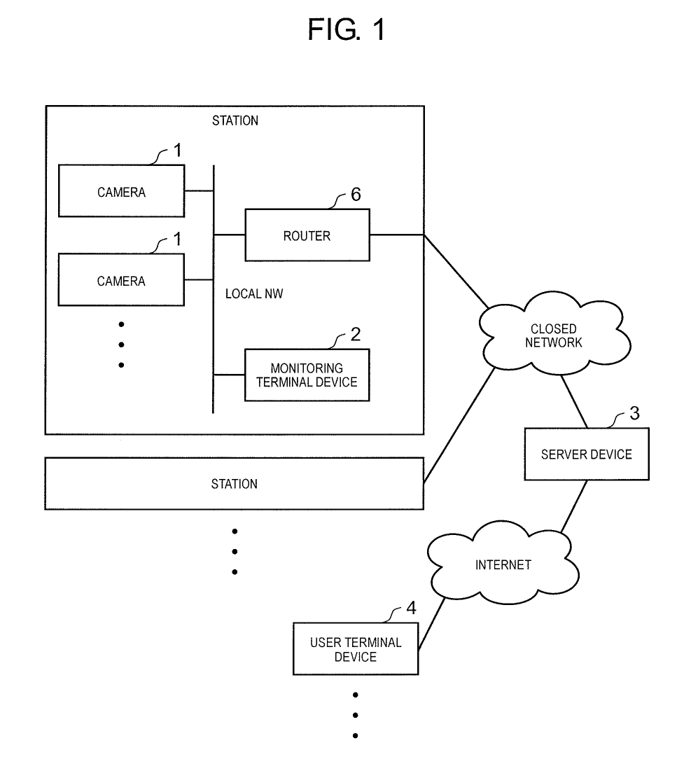

FIG. 1 is an overall configuration diagram of a monitoring system according to the first embodiment.

This monitoring system is a system for an observer to monitor the situation of the premises by images (moving image) of each area of the premises of the railway station (facility) and distribute the images of each area to general users, including camera (monitoring device) 1, monitoring terminal device 2, server device 3, user terminal device (browsing device) 4.

Camera 1 is installed in each target area such as a home or a ticket gate in a station building and images each target area. Camera 1 is connected to a closed area network such as a virtual local area network (VLAN via a local area network and router 6. In addition, in camera 1, image processing (privacy mask processing) for protecting the privacy of a person is performed, and a monitoring image (processed image) which is a moving image obtained by this image processing and an unprocessed image are output from camera 1.

Monitoring terminal device 2 is constituted with a PC and is installed in a monitoring room in the station building. Monitoring terminal device 2 is connected to camera 1 via a local area network. This monitoring terminal device 2 is a device for the observer to view images of camera 1 for the purpose of monitoring for security or disaster prevention, and unprocessed images are transmitted from each camera 1 to monitoring terminal device 2, the unprocessed images of each camera 1 are displayed on monitoring terminal device 2, the observer views the unprocessed images, and therefore it is possible to monitor the situation in the station.

Server device 3 is connected to each camera 1 at each station building via the closed area network and receives a monitoring image transmitted from each camera 1 at each station building. In addition, server device 3 is connected to user terminal device 4 via the Internet, generates a screen to be viewed by a user to distribute the screen to user terminal device 4, and acquires information input by the user on the screen.

User terminal device 4 is constituted with a smartphone, a tablet terminal, and a PC. In this user terminal device 4, a monitoring image distributed from server device 3 is displayed. The user views this monitoring image, and therefore it is possible to grasp the congested situation in the station building and the running situation of the train.

In server device 3, it is possible to perform live distribution in which a current monitoring image transmitted from camera 1 is distributed as it is. In addition, in server device 3, it is possible to accumulate the monitoring image transmitted from camera 1 and distribute the monitoring image of the date specified by user terminal device 4.

In such a monitoring system, since camera 1 and server device 3 are connected via the closed area network, it is possible to ensure the security of an unprocessed image output from camera 1. In addition, since server device 3 and user terminal device 4 are connected via the Internet, it is possible to access server device 3 from user terminal device 4 at any place.

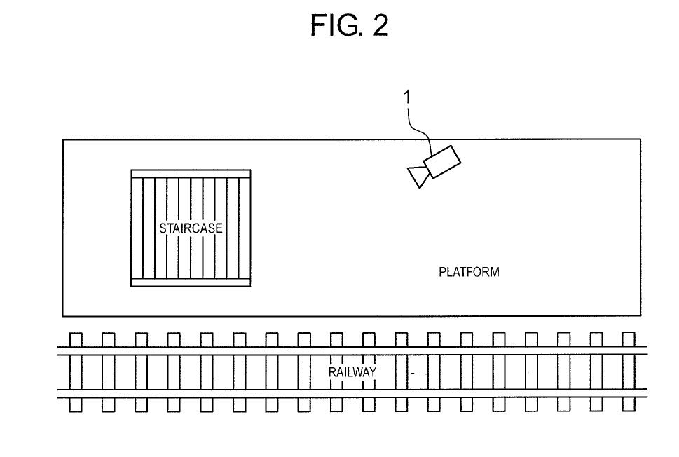

Next, the installation situation of camera 1 in the station building will be described. FIG. 2 is a plan view of an inside of the station building showing an example of the installation state of camera 1.

In the example shown in FIG. 2, camera 1 is installed on a platform in the station building. This camera 1 is installed on a ceiling or a pole of the platform, and a person present on the platform or a staircase is imaged. In particular, in the example shown in FIG. 2, a camera having a predetermined angle of view, a so-called box camera, is adopted as camera 1, but it is also possible to use an omnidirectional camera having a 360-degree imaging range using a fish-eye lens.

FIG. 2 shows an example of the platform, but camera 1 is installed so as to image an appropriately set target area such as a ticket gate or an escalator in the station building.

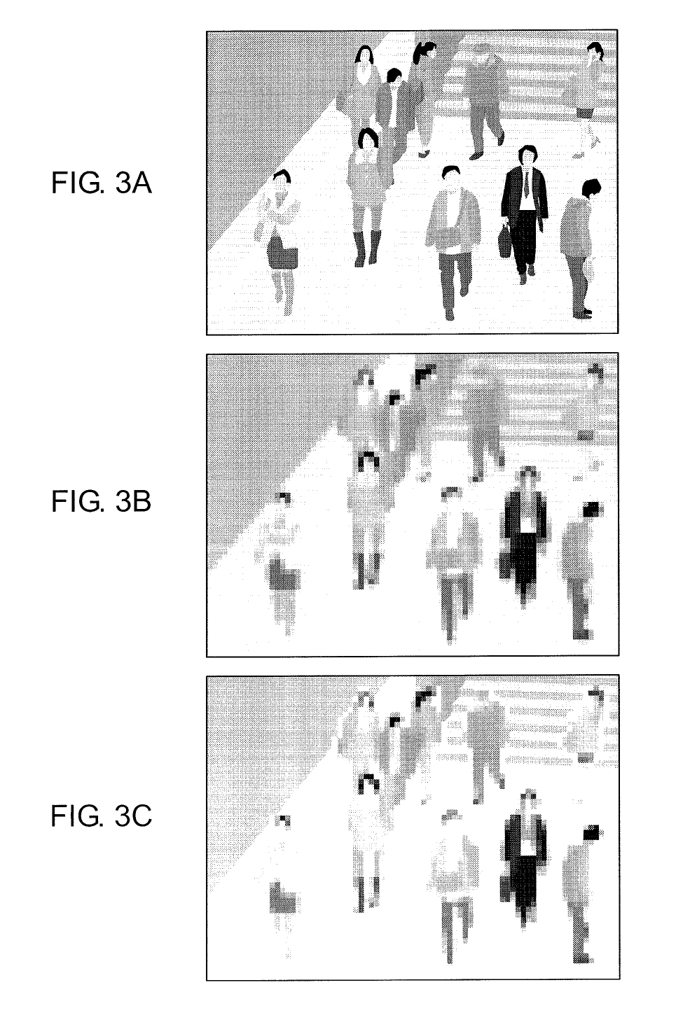

Next, an outline of image processing performed by camera 1 will be described. FIGS. 3A to 3C, FIGS. 4A to 4C, FIGS. 5A to 5C, and FIGS. 6A to 6C are explanatory views for explaining the outline of image processing performed by camera 1.

In camera 1, each area in the station building is imaged, and an unprocessed captured image shown in FIG. 3A is obtained. In this unprocessed captured image, since a person is captured as it is and individuals may be identified, the privacy of a person may not be protected. Therefore, in the present embodiment, image processing (privacy mask processing) for protecting the privacy of a person is performed.

Here, as the privacy mask processing, as shown in FIG. 3B, it is conceivable to perform image processing for reducing the identifiability of the object on the entire captured images. In addition, it is conceivable to perform moving object detection and person detection on the captured image, obtain position information of the image area of the person detected by this moving object detection and person detection, and perform image processing for reducing identifiability on the image area of the person (inside the contour of the person) as shown in FIG. 3C. In the example shown in FIGS. 3B and 3C, mosaic processing is performed as image processing for reducing identifiability.

When image processing for reducing identifiability is performed in this manner, since it becomes impossible to identify individuals, so it is possible to reliably protect the privacy of a person. However, in the image on which image processing for reducing identifiability is performed, it is possible to roughly recognize the outline of the imaging area, that is, where and what is located, but since it becomes impossible to easily recognize the state of a person who is coming and going, there is a problem that it is not possible to intuitively grasp the congested situation, that is, whether or not there are a lot of people.

On the other hand, as privacy mask processing, it is conceivable to perform moving object detection and person detection on the captured image and perform mask processing, that is, processing of changing (replacing) the image area of the person (inside the contour of the person) to a mask image on the person detected by this moving object detection and person detection.

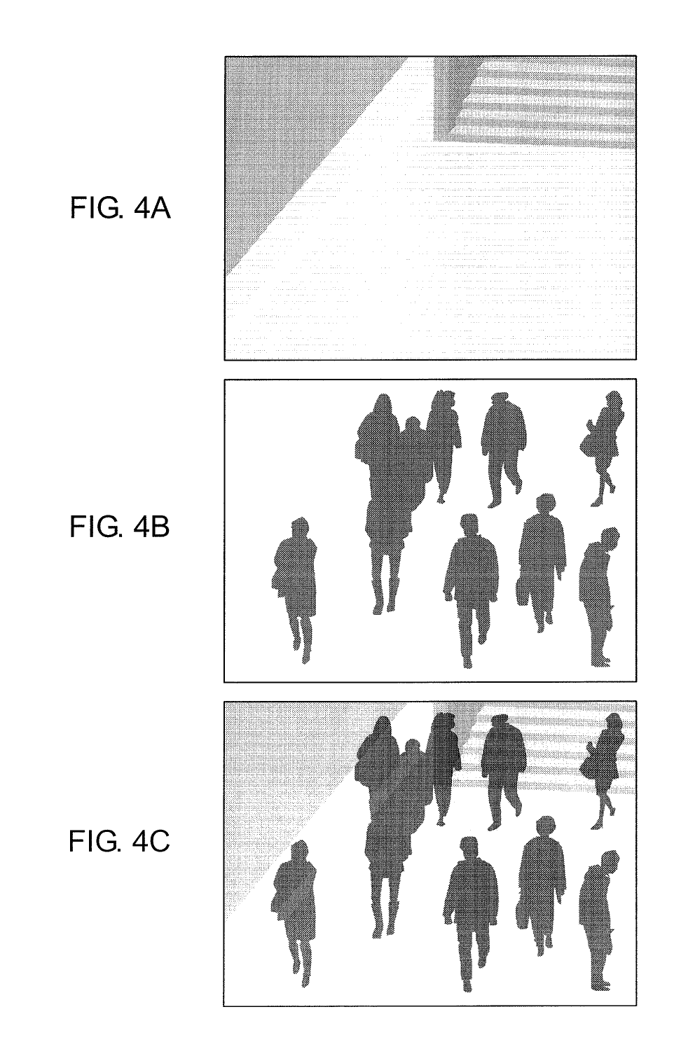

Specifically, as shown in FIG. 4A, a background image is generated by moving object removal processing (background image generation processing) for removing an image of a moving object (foreground image) from a plurality of captured images. In addition, as shown in FIG. 4B, a mask image covering the image area of a person is generated based on the detection results of moving object detection and person detection. Then, by superimposing the mask image shown in FIG. 4B on the background image shown in FIG. 4A, a masked image shown in FIG. 4C is generated. With this masked image, since it becomes impossible to identify individuals, the privacy of a person may be protected.

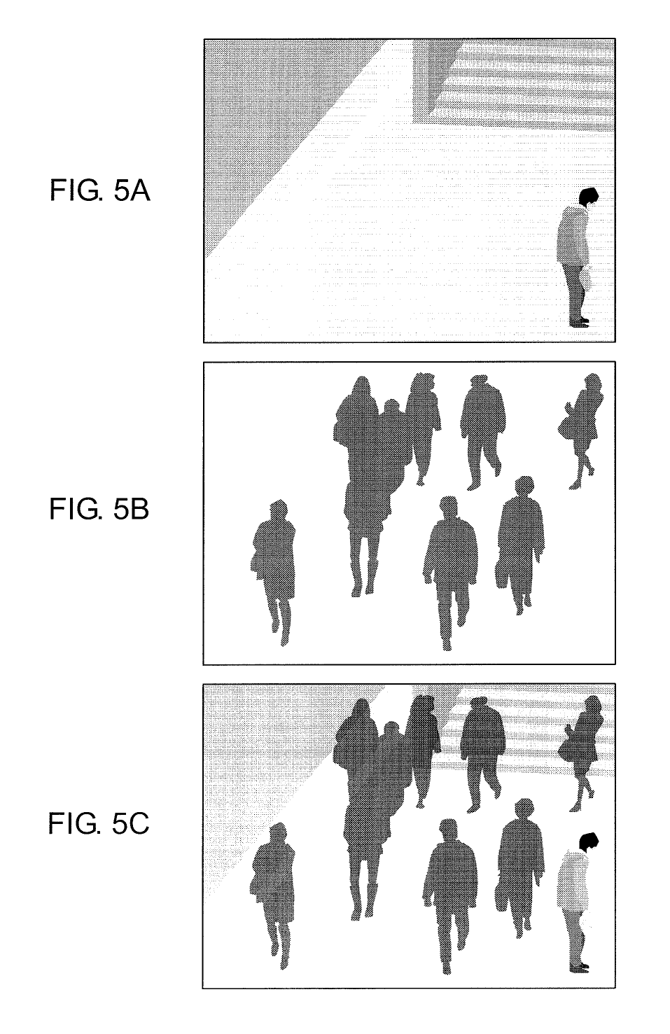

However, as shown in FIG. 5A, in a background image generated by moving object removal processing, a person with less movement may remain as it is. In this case, since the person with less movement is not detected even by moving object detection, as shown in FIG. 5B, a mask image of only the persons except that person is generated. Then, when the mask image shown in FIG. 5B is superimposed on the background image shown in FIG. 5A, a masked image shown in FIG. 5C is obtained. In this masked image, the person who could not be removed by the moving object removal processing is displayed as it is, and the privacy of the person may not be protected.

In addition. as shown in FIG. 3C. even in the case of performing the image processing for reducing identifiability on the image area of a person, when omission of detection occurs in moving object detection and person detection, the person whose detection fails remains in the background image, and the privacy of the person may not be protected.

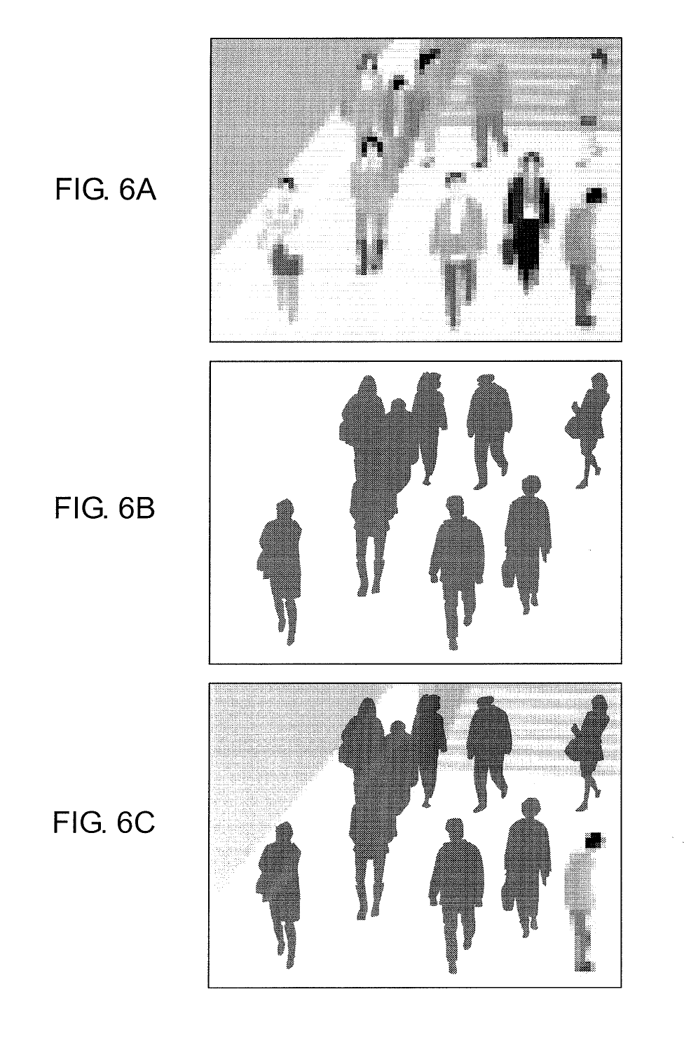

Therefore, in the present embodiment, as shown in FIG. 6A, an image (the same as in FIG. 3B) on which image processing for reducing identifiability is performed is used as a background image, and a masked image shown in FIG. 6C is generated by superimposing the mask image (same as FIG. 5B) shown in FIG. 6B on this background image.

In this way, since the moving object such as a person and the like may clearly be distinguished from the background and visually recognized by the mask image, it is possible to clearly grasp the state of the moving object. Therefore, it is possible to intuitively grasp the congested situation in the facility and the like. In addition, a person whose motion detection or person detection failed appears on the background image, but because individuals may not be identified by image processing for reducing identifiability on this background image, the privacy of a person may be reliably protected.

A person frame representing the face or the upper body area of the person may be displayed on the masked image based on the detection results of the moving object detection and the person detection. In a case where a plurality of people appear to overlap, when a mask image is displayed so as to cover the image area of the plurality of people, it is difficult to distinguish individual persons from each other, and it is sometimes impossible to easily grasp how many people are present, and in such a case, if a person frame is displayed, it is possible to easily grasp the number of people.

In addition, the color of the mask image may be changed according to the degree of congestion. For example, in a case where the degree of congestion is high, the mask image is displayed in red, and in a case where the degree of congestion is low, the mask image is displayed in blue. In addition, the degree of congestion may be expressed by contrasting density and transmittance with the same hue.

In this way, the color of the mask image and the like dynamically changes according to the congested situation, and it is possible to grasp the real situation of a target area. In addition, when monitoring images for each of a plurality of target areas are displayed side by side, it is possible to compare the degree of congestion in each target area and instantaneously grasp the state of the plurality of target areas. The degree of congestion may be obtained based on the detection result of person detection (corresponding to the number of people frames).

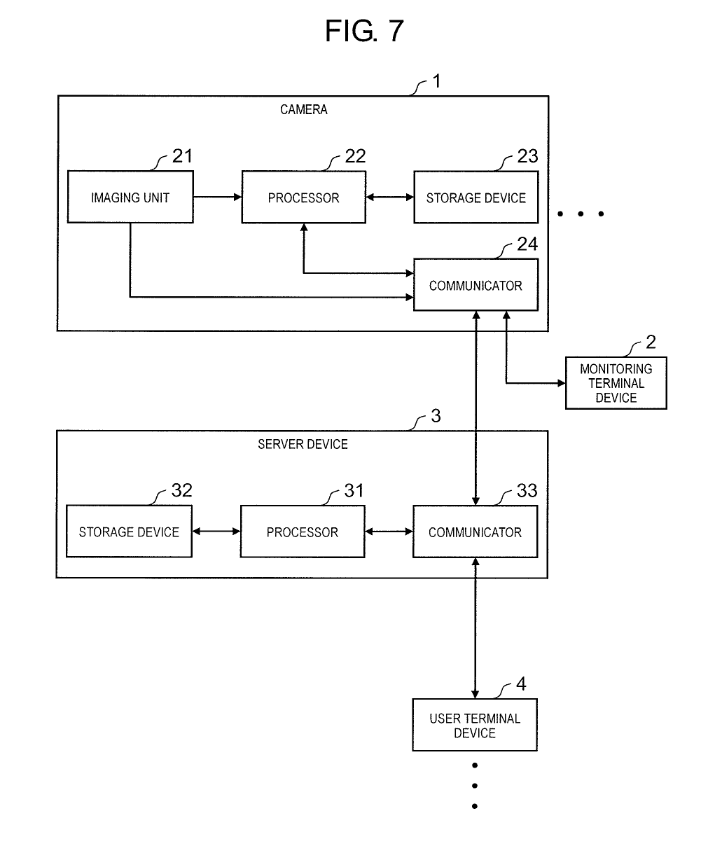

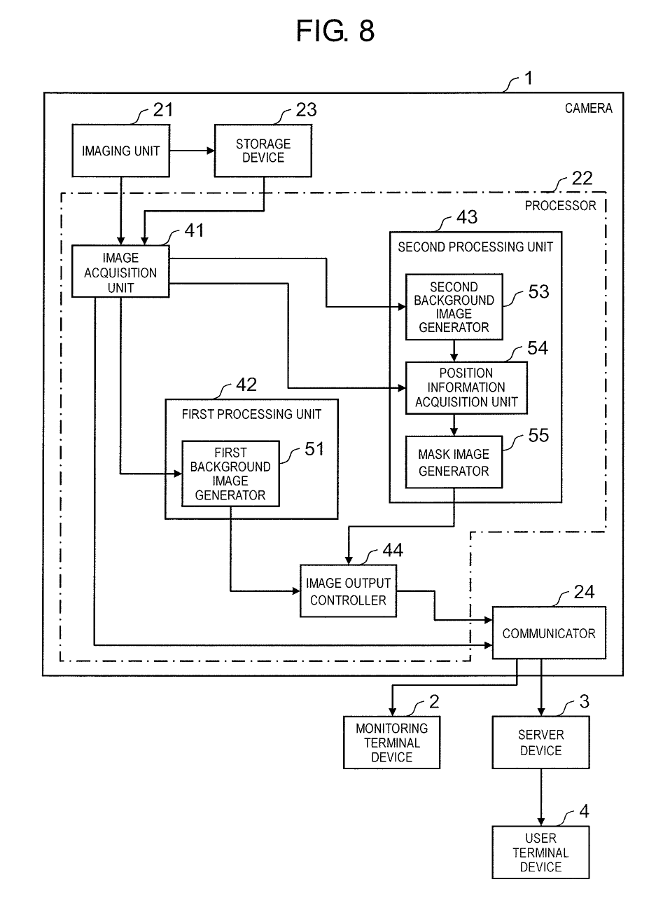

Next, a schematic configuration of camera 1 and the server device 3 will be described. FIG. 7 is a block view showing a hardware configuration of camera 1 and the server device 3. FIG. 8 is a functional block view of camera 1.

As shown in FIG. 7, camera 1 includes imaging unit 21, processor 22, storage device 23, and communicator 24.

Imaging unit 21 includes an image sensor and sequentially outputs captured images (frames) that are temporally continuous, that is, a so-called moving image. Processor 22 performs image processing on the captured image and generates and outputs a monitoring image. Storage device 23 stores a program executed by processor 22 or the captured image output from imaging unit 21. Communicator 24 transmits the monitoring image output from processor 22 to server device 3 via the network. In addition, communicator 24 transmits the unprocessed image output from imaging unit 21 to monitoring terminal device 2 via the network.

Server device 3 includes processor 31, storage device 32, and communicator 33.

Communicator 33 receives the monitoring image transmitted from each camera 1. In addition, communicator 33 distributes a screen including a monitoring image to be viewed by the user to user terminal device 4. In storage device 32, the monitoring image for each camera 1 received by communicator 33 and a program executed by processor 31 are stored. Processor 31 generates a screen to be distributed to user terminal device 4.

In addition, as shown in FIG. 8, camera 1 includes image acquisition unit 41, first processing unit 42, second processing unit 43, and image output controller 44. Image acquisition unit 41, first processing unit 42, second processing unit 43, and image output controller 44 are realized by causing processor 22 to execute a monitoring program (instructions) stored in storage device 23.

In image acquisition unit 41, the captured image captured by imaging unit 21 is acquired from imaging unit 21 and storage device (image storage) 23.

First processing unit 42 includes first background image generator 51. In first background image generator 51, a first background image (identifiability-reduced image) is generated by performing image processing for reducing the identifiability of an object captured in a captured image on the entire captured images. In the present embodiment, any one of image processing such as mosaic processing, blurring processing, and blending processing may be performed as image processing for reducing the identifiability of an object. In addition, a first background image (identifiability-reduced image) may be generated by lowering the resolution of the image to such an extent that the identifiability of the object is lost without performing such special image processing. In this case, since it is unnecessary to mount a special image processing function, first background image generator 51 may be constituted inexpensively and the amount of image data may be reduced, the communication load on the network may be reduced.

The mosaic processing is to divide a captured image into a plurality of blocks and replace the pixel values of all the pixels in the blocks with a single pixel value such as the pixel value of one pixel in the block or the average value of the pixel values of each pixel in the block.

The blurring processing is filtering processing by various kinds of filtering processing such as a blur filter, a Gaussian filter, a median filter, a bilateral filter, and the like. Furthermore, it is also possible to use various kinds of image processing such as negative/positive inversion, color tone correction (brightness change, RGB color balance change, contrast change, gamma correction, saturation adjustment, and the like), binarization, an edge filter, and the like.

The blending processing synthesizes (blends) two images in a semi-transparent state and synthesizes an image for a predetermined synthesis and a captured image based on an a value indicating the degree of synthesis.

Second processing unit 43 includes second background image generator 53, position information acquisition unit 54, and mask image generator 55.

In second background image generator 53, processing for generating a second background image from which an image (foreground image) of a person is removed from the captured image is performed. In this processing, a second background image is generated from a plurality of captured images (frames) in a nearest predetermined learning period, and the second background image is sequentially updated according to a new captured image to be acquired. A publicly known technique may be used for the processing performed by second background image generator 53.

In position information acquisition unit 54, processing for detecting a person from the captured image and acquiring position information of the image area of the person present in the captured image is performed. This processing is performed based on the second background image generated by second background image generator 53, in which the image area of the moving object is specified (moving object detection) from the difference between the captured image at the time of interest (current time in real-time processing) and the second background image acquired in the previous learning period. When a S2 shape constituted with the face, or the head and the shoulder portion of a person is detected in the image area of the moving object, the moving object is determined as a person (person detection). A publicly known technique may be used for the processing performed by position information acquisition unit 54.

The second background image in the present embodiment includes a so-called “background model”, and by building the background model from a plurality of captured images in the learning period in second background image generator 53 and by comparing the captured image at the time of interest with the background model in position information acquisition unit 54, the image area (foreground area) of the moving object and the background area are divided to obtain the position information of the image area of the moving object.

In addition, it is preferable that the second background image is sequentially updated as described above, but a captured image when no person is present, for example, a captured image before starting work may be held in the camera in advance as a second background image.

In mask image generator 55, based on the position information of the image area of the person acquired by position information acquisition unit 54, processing of generating a mask image having a contour corresponding to the image area of the person is performed. In this processing, information on the contour of the image area of the person is generated from the position information of the image area of the person, and a mask image representing the contour shape of the person is generated based on the information on the contour. This mask image is obtained by filling the inside the contour of a person with a predetermined color (for example, blue) and has transparency.

In image output controller 44, processing of generating a monitoring image (masked image) is performed by superimposing the mask image generated by mask image generator 55 on the first background image generated by first background image generator 51. In the present embodiment, the mask image has transparency, and in the monitoring image, the background image is transparent through the mask image portion.

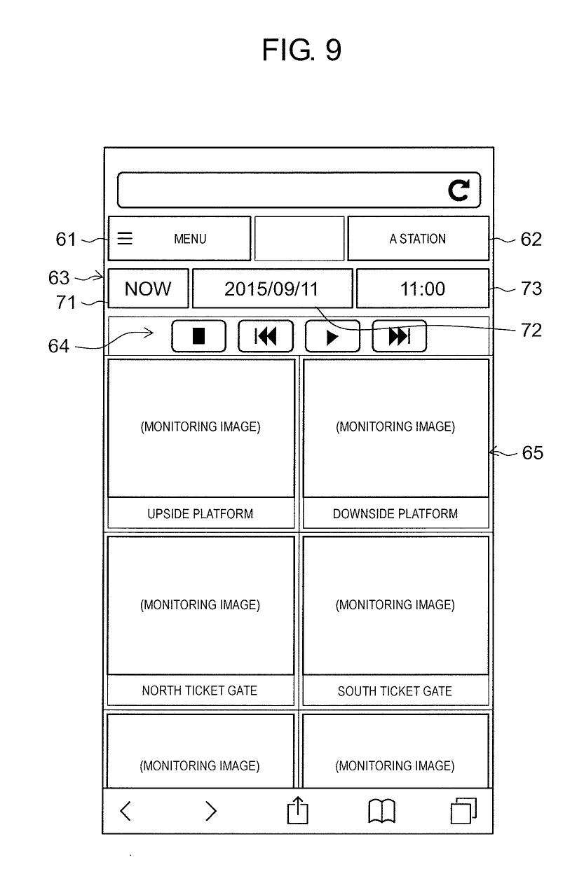

Next, a monitoring screen displayed on user terminal device 4 will be described. FIG. 9 is an explanatory view showing the monitoring screen displayed on user terminal device 4. FIG. 9 shows an example of a smartphone as user terminal device 4. The monitoring screen displayed on user terminal device 4 may be edited to contents for digital signage and displayed on a signage terminal (large display) installed at the station, a commercial facility or the like to indicate the current congested situation.

When user terminal device 4 activates a predetermined application and accesses server device 3, monitoring screen shown in FIG. 9 is displayed. When this monitoring screen is viewed by the user, it is possible to grasp the congested situation in the station.

The monitoring screen has main menu display button 61, station selection button 62, date and time input unit 63, reproduction operator 64, and image list display 65.

When main menu display button 61 is operated, the main menu is displayed. By using this main menu, it is possible to select station monitoring, user settings, and the like. When monitoring in the station building is selected, the monitoring screen shown in FIG. 9 is displayed.

In image list display 65, monitoring images for each target area such as a platform, a ticket gate, or the like in the station building are displayed side by side.

In station selection button 62, it is possible to select a station to be a target of the monitoring image to be displayed on image list display 65. In station selection button 62, the currently set station is displayed. When station selection button 62 is operated, a station selection menu is displayed so that the station may be changed.

Date and time input unit 63 is used to input the display date and time of the monitoring image to be displayed on image list display 65. In date and time input section 63, NOW button 71, date change button 72, and time change button 73 are provided.

With NOW button 71, the display date and time may be changed to the current time. In date change button 72, the display date may be changed. In date change button 72, the currently set display date is displayed. When date change button 72 is operated, a calendar screen (not shown) is displayed, and a date may be selected on this calendar screen. In time change button 73, the display time may be changed. The currently set display time is displayed on time change button 73. When time change button 73 is operated, a time selection menu is displayed, and the display time may be changed with this time selection menu. In an initial state, the monitoring image of the current time is displayed.

Reproduction operator 64 performs operations related to the reproduction of the monitoring images displayed on the image list display 65 and is provided with operation buttons for normal reproduction, fast forward reproduction, rewind reproduction, and stop, and by operating these operation buttons, it is possible to efficiently browse the monitoring images.

In addition, this monitoring screen may be enlarged and displayed by a pinch-out operation (operation of spreading two fingers touching the screen). Then, by moving the screen by performing a swipe operation (operation to shift the finger touching the screen) in an enlarged display state, the monitoring image of another area may also be viewed in the enlarged display. When a monitoring image is tapped (an operation to touch with a single finger for a short time), a screen for enlarging the monitoring image may be displayed.

In the present embodiment, the monitoring images of each area at the station selected by the user are displayed side by side in image list display 65, but an area selection button may be provided so that the monitoring image of the area selected by this area selection button may be displayed.

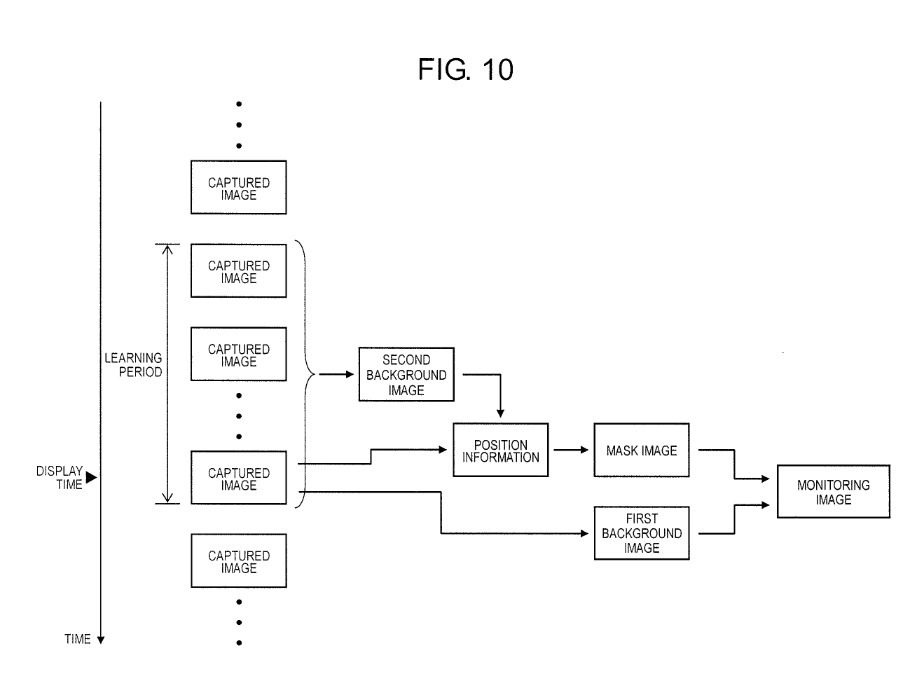

Next, an outline of image processing performed by camera 1 will be described. FIG. 10 is an explanatory view showing an overview of image processing performed by camera 1.

In this embodiment, in second background image generator 53, a second background image is generated from a plurality of captured images (frames) in a predetermined learning period with reference to display time (current time in real-time display). This processing is repeated each time a newly captured image is output from imaging unit 21, and the second background image is updated each time.

Next, in position information acquisition unit 54, position information for each person is acquired from the captured image and the second background image at the display time. Then, in mask image generator 55, a mask image is generated from position information for each person.

In addition, in first background image generator 51, image processing for reducing identifiability is performed on the captured image at the display time to generate a first background image. Then, in image output controller 44, a monitoring image in which the mask image is superimposed on the first background image is generated.

In this way, as the display time progresses, the second background image, the position information, the mask images, and the first background image at each time corresponding to the output timing of the captured image are acquired, and the monitoring images at respective times are sequentially output from camera 1.

The first background image may be generated from a captured image at each time. but a first background image may be generated by selecting a captured image that is the basis of the first background image while sorting the captured images at a predetermined interval.

In addition, in the present embodiment, an image obtained by performing image processing for reducing identifiability on a captured image is set as the first background image, but it is also possible to generate a first background image by performing image processing for reducing identifiability on the second background image generated for moving object detection.

As described above, in the present embodiment, a monitoring image in which a mask image is superimposed on the first background image (identifiability-reduced image) on which image processing for reducing identifiability is performed is generated and output. In this monitoring image, since the moving object such as a person and the like may clearly be distinguished from the background and visually recognized by the mask image, it is possible to clearly grasp the state of the moving object. Therefore, it is possible to intuitively grasp the congested situation in the station building and the like. In addition, the person whose motion detection failed appears on the first background image, but because individuals may not be identified in this first background image, the privacy of a person may be reliably protected.

### Second Embodiment

Next, a second embodiment will be described. The points not mentioned in particular here are the same as those in the above embodiment.

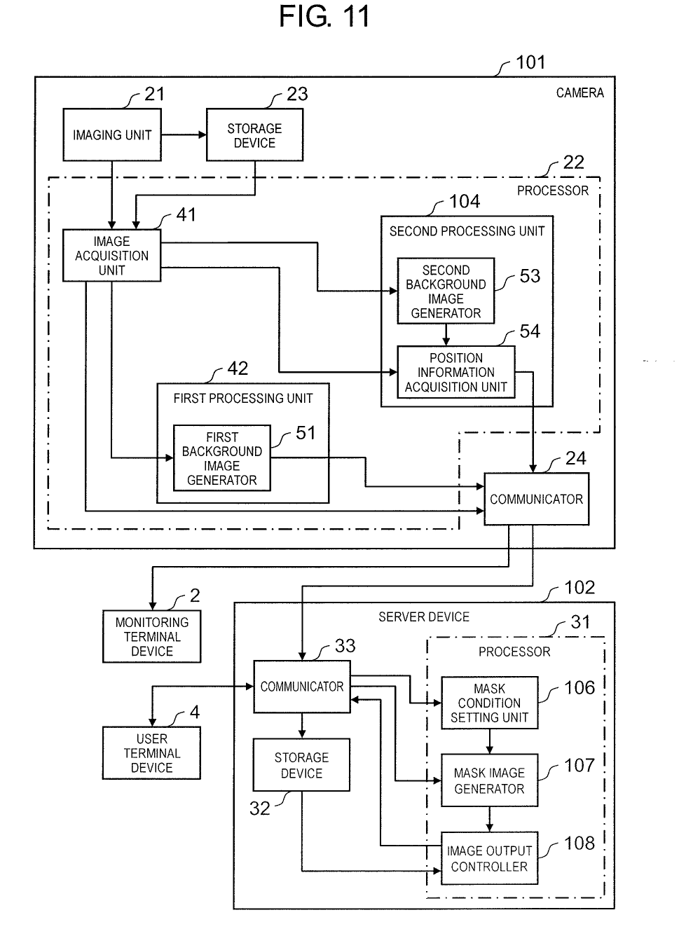

FIG. 11 is a functional block view showing a schematic configuration of a camera 101 and a server device 102 according to the second embodiment.

In the first embodiment, a first background image and a mask image are generated in camera 1, and a monitoring image in which the mask image is superimposed on the first background image is generated and output, but in the second embodiment, the first background image and the position information of the image area of the person are transmitted from camera 101 to server device 102 so that the display elements of the mask image may be changed for each user, and in server device 102, a mask image is generated in accordance with the contents of the display elements specified by the user, and a monitoring image in which the mask image is superimposed on the first background image is generated.

Like the previous embodiment, camera 101 includes image acquisition unit 41, first processing unit 42, and second processing unit 104, but in second processing unit 104, mask image generator 55 provided in second processing unit 43 in the first embodiment (see FIG. 8) is omitted. In addition, image output controller 44 provided in the first embodiment is also omitted.

Server device 102 includes mask condition setting unit 106, mask image generator 107, and image output controller 108. Mask condition setting unit 106, mask image generator 107, and image output controller 108 are realized by causing processor 31 to execute the monitoring program (instructions) stored in storage device 32.

In mask condition setting unit 106, various conditions relating to the mask image are set according to the user's input operation at user terminal device 4. In mask image generator 107. a mask image is generated based on the mask conditions for each user set in mask condition setting unit 106 and the position information acquired from camera 1. In the present embodiment, in mask condition setting unit 106, mask conditions related to the display elements of the mask image is set for each user, and in mask image generator 107, a mask image is generated in accordance with the contents of the display elements specified by the user.

In image output controller 108, processing of generating a monitoring image (masked image) is performed by superimposing the mask image generated by mask image generator 107 on the first background image acquired from camera 1. As a result, the monitoring image in which the mask image in accordance with the contents of the display elements specified by the user appears is displayed on user terminal device 4.

In the present embodiment, a mask image is generated in server device 102, but a mask image may be temporarily generated in camera 101 and the mask image may be adjusted by image editing in server device 102 in accordance with the contents of the display elements specified by the user.

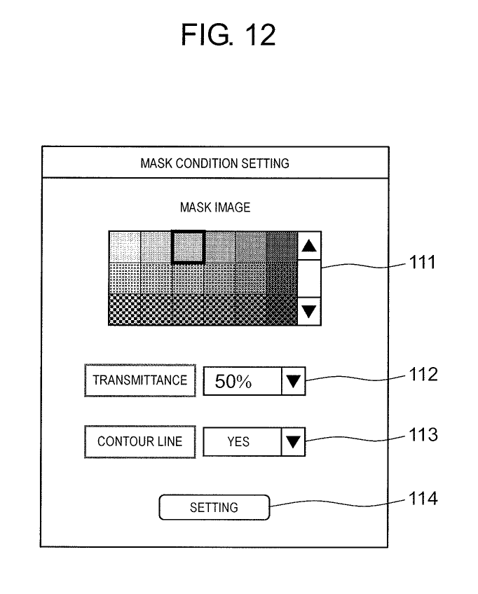

Next, the setting of mask conditions will be described. FIG. 12 is an explanatory view showing a mask condition setting screen displayed on user terminal device 4.

When the user setting is selected on the main menu displayed by main menu display button 61 of the monitoring screen shown in FIG. 9, a user setting menu is displayed, and when the mask condition setting is selected in this user setting menu. the mask condition setting screen shown in FIG. 12 is displayed. With this mask condition setting screen, the user may change the display elements of the mask image.

On the mask condition setting screen, a filling selector 111, a transmittance selector 112, a contour line drawing selector 113, and a setting button 114 are provided.

In the filling selector 111, the user selects a filling method (color, pattern, and the like) inside the contour line in the mask image from a tile menu. In the transmittance selector 112, the user selects the transmittance of the mask image from a pull-down menu. The transmittance may be selected in the range of 0% to 100%. That is, in a case where the transmittance is 0%, the first background image is completely invisible, and in a case where the transmittance is 100%, the first background image appears as it is. In the contour line drawing selector 113, the user selects whether or not to draw a contour line in the mask image from a pull-down menu. Here, in a case where the transmittance is 100% and no contour line is selected, the monitoring image is displayed with the person being erased.

When the filling method of the mask image, the transmittance and the presence/absence of the contour line drawing are selected with filling selector 111, transmittance selector 112, and contour line drawing selector 113 and setting button 114 is operated, the input contents are transmitted to server device 102, and processing of setting the mask conditions of the user is performed in mask condition setting unit 106.

In addition. as described above, in the case of changing the color of the mask image to the color specified according to the degree of congestion (corresponding to the number of people frames) (in the mode in which the mask image is displayed in red in a case where the degree of congestion is high and the mask image is displayed in blue in a case where the degree of congestion is low or the mode in which the degree of congestion is represented by contrasting density and transmittance with the same hue), in place of the selection of the mask image in filling selector 111, a congested state display mode may be provided on the mask condition setting screen so that the user may select on/off of the mode.

As described above, in the present embodiment, since the user may change at least one of the display elements of the color, the transmittance, and the presence/absence of the contour line of the mask image, it is possible to display a monitoring image that is easy for the user to see.

In the present embodiment, mask condition setting unit 106 is provided in server device 102 so that the display elements of the mask image may be changed for each user, but a mask condition setting unit may be provided in camera 1 (see FIG. 8) of the first embodiment, and in this mask condition setting unit, mask conditions may be set according to the operation input by the user, and mask image generator 55 may generate a mask image based on the mask conditions. In this way, for example, a user such as an administrator may freely change the display element of the mask image for each camera 1.

As described above, the embodiment has been described as an example of the technique disclosed in the present application. However, the technique in the present disclosure is not limited thereto and may also be applied to embodiments in which change, replacement, addition, omission, and the like are performed. In addition, it is also possible to combine the constituent elements described in the above embodiments into a new embodiment.

As a modification of the above embodiment, in place of the mask image of the contour shape of the person, a rectangular mask image corresponding to a person frame may be used based on the detection results of moving object detection and person detection. In this case, only the shape of the mask image corresponding to the image area of the person changes, and the setting desired by the user, such as the mask conditions described in the above embodiment, may be performed.

In addition, in the above embodiment, an example of a railway station has been described, but it is not limited to such a railway station, but the embodiment may be widely applied to various facilities such as a theme park, an event venue, and the like. In addition, a bus stop, a sidewalk, a road, and the like where a camera (monitoring device 1) is installed are also included in a target facility, and the technique according to the present disclosure may also be applied to these target facilities.

In addition, in the above embodiment, an example in which a moving object to be masked is a person has been described, but a moving object other than a person, for example, a vehicle such as a car, a bicycle, and the like may be used as a target. Even for a moving object other than such a person, in a case where it is possible to identify the owner or user thereof, consideration not to infringe personal privacy is required.

In addition, in the above embodiment, image processing for reducing identifiability is performed on the entire captured images, but an area where it is clear that a person does not appear, such as a ceiling of a building and the like, may be excluded from the target of image processing of reducing identifiability. In this way, it becomes easier to grasp the situation of the target area.

In this case, an administrator or the like may manually set an area to be excluded from image processing for reducing identifiability, but an area to be excluded from the image processing for reducing identifiability may be set based on the detection result of moving object detection. That is, an area in which a moving object is not detected for a certain period of time or more by moving object detection may be excluded from the target of image processing for reducing identifiability. In addition, the effect of image processing for reducing identifiability may be gradually reduced as the time during which no moving object is detected continues.

In addition, in the above embodiment, in the camera, first processing of generating a first background image in which the identifiability of an object is reduced, second processing of generating a mask image, and image output control of superimposing the mask image on the background image are performed, but all or a part of these kinds of necessary processing may be performed by the PC. In addition, even if all or a part of the necessary processing may be performed by a recorder (image storage device) that accumulates the images output from the camera or an adapter (image output control device) that controls the images output from the camera.

### INDUSTRIAL APPLICABILITY

The monitoring device, the monitoring system, and the monitoring method according to the present disclosure have an effect of reliably protecting the privacy of a person and displaying a monitoring image from which a congested situation and the like in a facility may be intuitively grasped and are useful as a monitoring device, a monitoring system, a monitoring method, and the like that generate and output a monitoring image on which privacy mask processing is performed on a captured image of a target area.

### REFERENCE MARKS IN THE DRAWINGS

1 CAMERA (MONITORING DEVICE)

3 SERVER DEVICE

4 USER TERMINAL DEVICE

21 IMAGING UNIT

22 PROCESSOR

23 STORAGE DEVICE

24 COMMUNICATOR

41 IMAGE ACQUISITION UNIT

42 FIRST PROCESSING UNIT

43 SECOND PROCESSING UNIT

44 IMAGE OUTPUT CONTROLLER

51 FIRST BACKGROUND IMAGE GENERATOR

53 SECOND BACKGROUND IMAGE GENERATOR

54 POSITION INFORMATION ACQUISITION UNIT

55 MASK IMAGE GENERATOR

101 CAMERA

102 SERVER DEVICE

104 SECOND PROCESSING UNIT

106 MASK CONDITION SETTING UNIT

107 MASK IMAGE GENERATOR

108 IMAGE OUTPUT CONTROLLER

111 FILLING SELECTOR

112 TRANSMITTANCE SELECTOR

113 CONTOUR LINE DRAWING SELECTOR

1. A monitoring device comprising:
a processor,
wherein the monitoring device generates and outputs a monitoring image on which privacy mask processing is performed on a captured image obtained by imaging a target area, and
the processor
performs image processing for reducing identifiability of an object appearing in the captured image on the captured image,
detects a moving object from the captured image to generate a mask image corresponding to an image area of the moving object, and
generates and outputs the monitoring image on which the mask image is superimposed on an identifiability-reduced image.

2. The monitoring device of claim 1,
wherein the processor executes any of mosaic processing, blurring processing, and blending processing as image processing for reducing identifiability of the object.

3. The monitoring device of claim 1,
wherein the processor generates a transparent mask image representing a contour shape of the moving object.

4. The monitoring device of claim 1,
wherein the processor generates the mask image in accordance with a mask condition set according to an operation input by a user, and under the mask condition, at least one display element of color, transmittance, and presence/absence of a contour line of the mask image may be changed.

5. The monitoring device of claim 1,
wherein the processor generates the mask image in accordance with a mask condition set according to an operation input by a user, and
as the mask condition, a congested state display mode in which the mask image is generated with a color specified by a degree of congestion or contrasting density and transmittance with the same hue may be set.

6. A monitoring system that generates a monitoring image on which privacy mask processing is performed on a captured image obtained by imaging a target area to distribute the image to a user terminal device, the system comprising:
a camera that images the target area;
a server device that distributes the monitoring image to the user terminal device; and
the user terminal device,
either the camera or the server device
performs image processing for reducing identifiability of an object appearing in the captured image on the captured image,
detects a moving object from the captured image to generate a mask image corresponding to an image area of the moving object, and
generates and outputs the monitoring image on which the mask image is superimposed on an identifiability-reduced image.

7. A monitoring method for causing an information processing device to perform processing of generating and outputting a monitoring image on which privacy mask processing is performed on a captured image obtained by imaging a target area, the method comprising:
performing image processing for reducing identifiability of an object appearing in the captured image on the captured image to generate an identifiability-reduced image;
detecting a moving object from the captured image to generate a mask image corresponding to an image area of the moving object; and
generating and outputting the monitoring image in which the mask image is superimposed on the identifiability-reduced image.
